(19) United States
(12) Patent Application Publication
(10) Pub. No.: US 2025/0038509 A1
(43) Pub. Date: Jan. 30, 2025

(54) MODULAR ELECTRIC VEHICLE CHARGING FOUNDATION SYSTEM

(71) Applicant: NAL LIMITED, WORCESTER, WORCESTERSHIRE (GB)

(72) Inventors: Benjamin PARSONS, WORCESTER (GB); Stephen ANDREWS, WORCESTER (GB); Brian WATTS, WORCESTER (GB); Samantha EVANS, WORCESTER (GB); Steven BROOKER, WORCESTER (GB)

(73) Assignee: NAL LIMITED, WORCESTER, WORCESTERSHIRE, GB (GB)

(21) Appl. No.: 18/574,794

(22) PCT Filed: Jun. 27, 2022
(86) PCT No.: PCT/GB2022/051639

§ 371 Date: Dec. 28, 2023

(30) Foreign Application Priority Data
Jun. 28, 2021 (GB) 2109300.0
Apr. 19, 2022 (GB) 2205694.9

(51) Int. Cl. H02G 9/10; B60L 53/31; E02D 27/46; H02G 3/04

(52) U.S. Cl. CPC H02G 9/10; B60L 53/31; E02D 27/46; H02G 3/0493

(57) ABSTRACT

A modular foundation system is provided which comprises a base structure defining a cabling void, and a raising frame element connected or connectable to an upper portion of the base structure, the raising frame comprising an adapter coupling. An electric-vehicle-charger adapter plate is then provided having a cabling aperture therethrough. The electric-vehicle-charger adapter plate is releasably engagable with the adapter coupling to provide a foundation for an electric vehicle charger once installed. A blanking cover releasably engagable with the adapter covering is also provided, the electric-vehicle charger adapter plate and blanking cover being selectably interchangeable.

### CROSS-REFERENCES TO RELATED APPLICATIONS

This application claims priority to two British applications: GB2109300.0, filed 28 Jun. 2021 and GB2205694.9, filed 19 Apr. 2022 which are hereby incorporated herein by reference.

### FIELD OF THE INVENTION

The present invention relates to a modular foundation system preferably but not necessarily exclusively for the installation of electric vehicle chargers, as well as to a modular electric vehicle charging system. A method of reducing groundwork requirements for an electric vehicle charger installation site is also provided.

### BACKGROUND OF THE INVENTION

Electric vehicle chargers are becoming more commonplace as road furniture as the market for electric vehicles expands. The size of the ducting which brings the cabling to the electric vehicle charger subsurface is large, making it difficult to manoeuvre into position and install.

At present, electric vehicle chargers are installed by bolting the electric vehicle charger of choice into a large concrete slab in the ground, with the ducting penetrating through the concrete slab, and being held in place thereby. Since different chargers from different manufacturers have different requirements for cabling, having different mounting and cabling entry points, this means that to replace the electric vehicle charger with another of a different construction, the entire site must be excavated. This is extremely time-consuming.

Examples of supports for road furniture known in the art are disclosed in DE102019007858A1, U.S. Pat. No. 20,133,09022A1, EP2878734B1, JPH11205983A, DE102005016491A1, and EP2453544A2.

It is an object of the present invention to reduce the civil works required to extract and reinstall a site for electric vehicle charger architecture.

According to a first aspect of the invention, there is provided a modular foundation system comprising: a base structure defining a cabling void; a raising frame element connected or connectable to an upper portion of the base structure and having an adapter coupling and a perimetric flange, the perimetric flange being seated on a top of the base structure, and the adapter coupling extending upwardly from the perimetric flange to form a top support member; an adapter plate having a plate body, a cabling aperture therethrough and a plurality of mounting points on the plate body for onward connection to an item of road furniture, the adapter plate being releasably engagable with the adapter coupling to provide a foundation for an item of road furniture once installed; and a blanking cover releasably engagable with the adapter coupling, the adapter plate and blanking cover being selectably interchangeable. Preferably, the adapter plate may be an electric-vehicle-charger adapter plate to provide a foundation for an electric vehicle charger, wherein at least part of the plate body extends laterally outwardly from the adapter coupling relative to an in-use vertical axis, said at least part of the plate body comprising the plurality of mounting points so as to overhang the adapter coupling.

The present invention is in effect a universal foundation system, specifically but not necessarily exclusively for electric vehicle chargers, which is achieved by the provision of an adapter plate for an electric vehicle charger with a corresponding blanking plate which is selectably interchangeable. This allows the groundworks to be completed to install the subsurface components and blanked off before the charger is itself installed. Any electric vehicle charger can be installed, regardless of fixing points or cable entry points, and extra raising frame elements and base structures can be installed to upgrade the scale of a site with more units very easily.

This has many advantages. The installation time is reduced, and all civils works can be completed without prior knowledge of the charger type to be used. The appearance of the site pre-installation is also significantly improved, since there is no unsightly ducting projecting through a concrete slab.

The electric-vehicle-charger adapter plate may comprise at least one locator which depends from the plate body.

A depending locator of the adapter plate helps to align the adapter plate accordingly, simplifying installation thereof to the raising frame element.

Optionally, at least part of the electric-vehicle-adapter plate may extend laterally outwardly from the perimetric flange of the raising frame element relative to an in-use vertical axis.

It will be appreciated that the use of the substantial base structure ensures that the centre of gravity of the whole system is stable, and thus overhanging of the structure by the adapter plate is possible. Larger chargers can thus be installed on small structure.

Preferably, the base structure may be formed from a plurality of interengagable base portions.

The ability to alter the dimensions of the base structure is highly useful, since the volume of the cabling void can be dimensioned according to need.

The base portions may be stackable on top of one another.

Stackable base portions are extremely useful. The base structure can be adjusted in height to suit a bend radius of the cabling, since the cabling for electric vehicle chargers is resistant to flexion.

The base structure may further comprise a base member having an anchoring connector thereon; and a securing element connectable with the anchoring connector and connectable to the raising frame element to clampingly secure the base portions between the base member and the raising frame element.

The clamping structure of the base may serve to make installation of a modular sub-surface assembly more straightforward, particularly as in the specific embodiment illustrated, the securing of the securing elements in position is all achievable from above. This may negate the need for an installer to enter the trench.

Optionally, the base structure may comprise an inner wall and an outer wall, wherein the inner and outer walls define a securing element channel for receiving the securing element.

The securing element channel may simplify location of the securing elements into the anchoring connectors, and/or help with alignment of the base structure.

Preferably, the securing element and the anchoring connector may screw-threadingly interengage with one another.

Screw-threaded engagement is the simplest means of achieving top-down assembly of the clamping structure.

The base member may comprise at least one locator for locating at least one base portion thereon.

The provision of one or more locators helps simplify the assembly of the base structure.

Optionally, the adapter coupling may be formed having a rectilinear cross-section. Alternatively, the adapter coupling may be formed having a tubular cross-section.

Different above-ground frame sections may be more applicable in particular contexts, so different forms of adapter coupling may have different uses and associated advantages.

Optionally, the raising frame element may comprise a plurality of receivers engagable with fastening elements through the blanking cover.

Optionally, the plurality of receivers may be each positioned laterally inward of the adapter coupling relative to the perimetric flange.

According to a second aspect of the invention, there is provided a modular electric vehicle charging system comprising a modular foundation system in accordance with the first aspect of the invention, and an electric vehicle charger engagable with the adapter plate.

Whilst the present invention has been prepared with electric vehicle chargers in mind, the direct interchangeability of an adapter plate and blanking cover at a single raising frame point has not been posited in the art to date.

The invention will now be more particularly described, by way of example only, with reference to the accompanying drawings, in which:

### BRIEF DESCRIPTION OF THE DRAWINGS

FIG. 1 shows a perspective representation of a first embodiment of a modular electric vehicle charging foundation system in accordance with the first aspect of the invention, with the system being shown in FIG. 1(a) in an exploded condition, and an adapter plate being shown alone in FIG. 1(b);

FIG. 2 shows a side view of the modular electric vehicle charging foundation system of FIG. 1 in an installed state;

FIG. 3 shows a plan view of the modular electric vehicle charging foundation system of FIG. 1;

FIG. 4 shows a cross-sectional representation of the modular electric vehicle charging foundation system of FIG. 3 taken along line A-A, with inset FIG. 4(i) showing the detail of the connection between the base structure and raising frame element;

FIG. 5 shows a perspective view of the modular electric vehicle charging foundation system of FIG. 1 in use with an indicative electric vehicle charger;

FIG. 6 shows a perspective representation of the modular electric vehicle charging foundation system of FIG. 1 having a blanking cover thereon;

FIG. 7 shows a perspective view of a second embodiment of a modular electric vehicle charging foundation system in accordance with the first aspect of the invention, inclusive of a blanking cover;

FIG. 8 shows an exploded perspective view of the modular electric vehicle charging foundation system of FIG. 7;

FIG. 9 shows an exploded perspective representation of the modular electric vehicle charging foundation system of FIG. 7, including a second embodiment of adapter plate;

FIG. 10 shows an exploded perspective representation of the modular electric vehicle charging foundation system of FIG. 9 the system being shown in full in FIG. 10(a) and the adapter plate being shown in detail in FIG. 10(b);

FIG. 11 shows a cross-sectional representation of the modular electric vehicle charging foundation system of FIG. 9, inset FIG. 11(a) showing the connection between the blanking cover and raising frame element, and inset FIG. 11(ii) showing the connection between the base structure and raising frame element;

FIG. 12 shows an exploded perspective representation of the modular electric vehicle charging foundation system of FIG. 7 including a third embodiment of adapter plate;

FIG. 13 shows an exploded perspective representation of the modular electric vehicle charging foundation system of FIG. 7 including a fourth embodiment of adapter plate;

FIG. 14 shows a perspective representation of a third embodiment of a modular electric vehicle charging foundation system in accordance with the first aspect of the invention; and

FIG. 15 shows an exploded perspective representation of the modular electric vehicle charging foundation system of FIG. 14.

### DETAILED DESCRIPTION OF THE DRAWINGS

The invention will now be more particularly described, by way of example only, with reference to the accompanying drawings.

All publications disclosed and referenced mentioned herein are hereby incorporated herein by reference including priority applications: GB2109300.0, filed 28 Jun. 2021 and GB2205694.9, filed 19 Apr. 2022.

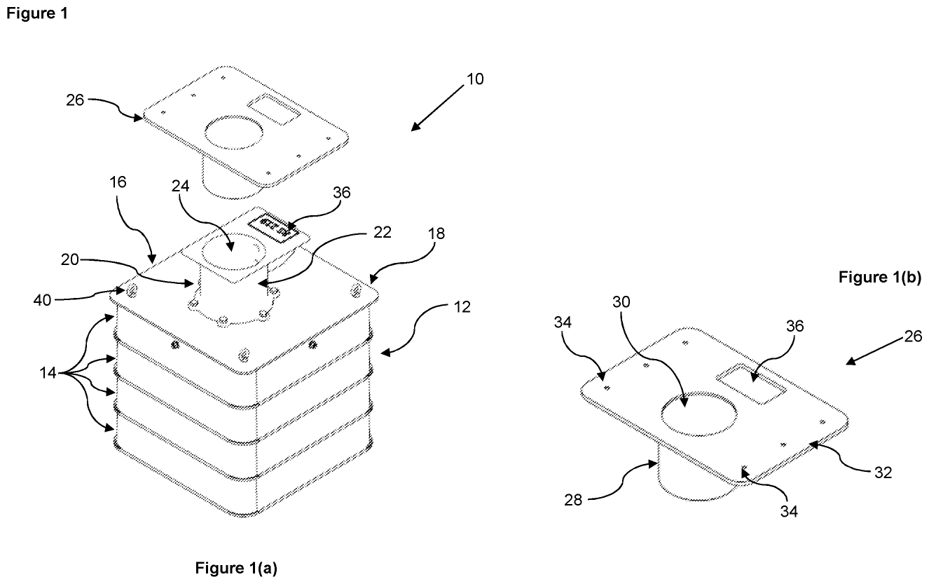

Referring to FIG. 1, there is indicated a modular electric vehicle charging foundation system, referenced globally at 10. This system 10 is suitable for the purpose of installing electric vehicle chargers in a location in a manner which allows for straightforward upgrade or replacement of the electric vehicle charger.

As best seen in FIG. 1(a), the modular electric vehicle charging foundation system 10 comprises a base structure 12, which is here formed as a plurality of modularly engagable sub-surface base portions 14 which stackably engage on top of one another to a desired height. The base structure 12 is in use installed in a trench at a groundworks site. The base structure 12 is often informally referred to as a chamber or plinth.

In this embodiment, the base structure 12 is formed having a square or substantially square footprint, but it will be apparent that an appropriately dimensioned base structure 12 will be utilised in the field in a context-dependent manner. The base structure 12 thus defines an appropriate cabling void for receiving electric charging cables, which may be larger, thicker, and/or less flexible than other similar cables for road furniture.

The modular electric vehicle charging foundation system 10 further includes a raising frame element 16, which is formed to be receivable directly onto the base structure 12. In practice, the installer will attach the raising frame element 16 to the top base portion 14 during installation before fully assembling the base structure 12.

The raising frame element 16 has a perimetric flange 18 which extends to the edge of the top surface of the base structure 12 to form a complete perimetric lid. There is then also an adapter coupling 20, which may or may not be integrally formed with the perimetric flange 18. In the illustrated embodiment of FIG. 1(a), the adapter coupling 20 comprises a tubular neck portion 22 extending upwardly from the perimetric flange 18. An aperture 24 through the neck portion 22 is dimensioned to permit access therethrough for electric vehicle charging cables without kinking.

The adapter coupling 20 further includes a top support member 24 which allows for an electric-vehicle-charger adapter plate 26, such as that shown in FIG. 1(b), to be fastened thereto. The electric-vehicle-charger adapter plate 26 here has a collar 28 which has a complementary cylindrical shape for being receivably inserted into the neck portion 22, and which defines a cabling aperture 30 therethrough, whilst a plate body 32 of the electric-vehicle-charger adapter plate 26 has a plurality of mounting points 34 for onward connection onto an associated electric vehicle charger. The plate body 32 of the electric-vehicle-charger adapter plate 26 includes an access aperture 36 therein to permit access to a connection region 38 of the adapter coupling 20 when connecting the electric-vehicle-charger adapter plate 26 to the raising frame element 16.

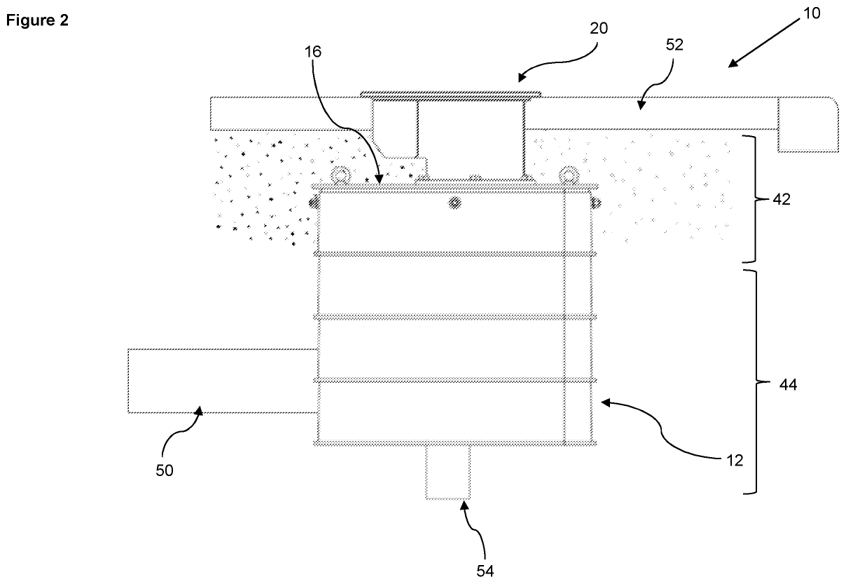

The adapter coupling 20 here has a plurality of mounting lugs 40 which extend through the perimetric flange 18, and which, when installed, provide security in the installation medium. This is illustrated as a concrete layer 42 over a compactable aggregate 44, as shown in detail in FIG. 2.

The subsurface installed structure of the modular electric vehicle charging foundation system 10 can be seen in detail in FIG. 2. An incoming cable conduit 50 is provided which enters the cabling void of the base structure 12 underground, typically in the compactable aggregate layer 44. The concrete layer 42 is provided part way up the neck portion 22 of the adapter coupling 20, with a top finishing layer 52 then being provided up to the bottom of the top support member 24, so that the top support member 24 is or is substantially flush with the final top finishing layer 52. This provides a suitable base for an electric-vehicle-charger adapter plate 26 to be selectably mounted thereon.

The base structure 12 is further engaged with a sump 54 at the base of the trench in which the base structure 12 has been originally installed, to collect undesirable liquids ingressing into the base structure 12, thereby protecting the electrical cabling.

The electric-vehicle-charger adapter plate 26 is then installed on top of the adapter coupling 20 by insertion of the collar 28 into the neck portion 22, which ensures that a consistent passage is provided up through the electric-vehicle-charger adapter plate 26 from the cabling void.

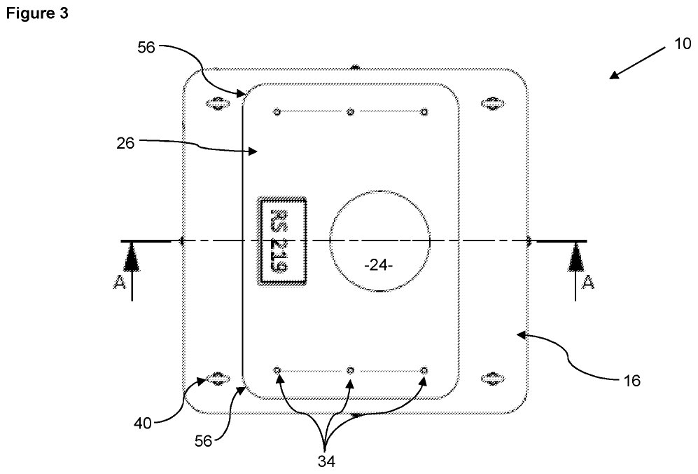

The engagement can be best seen in FIG. 3, which is the plan view. The electric-vehicle-charger adapter plate 26 is installed such that the access aperture 36 is aligned with the connection region 38 of the adapter coupling 20. The lateral sides 56 of the plate body 32 overhang the adapter coupling 20 so as to leave the mounting points 34 free for engagement with an electric vehicle charger.

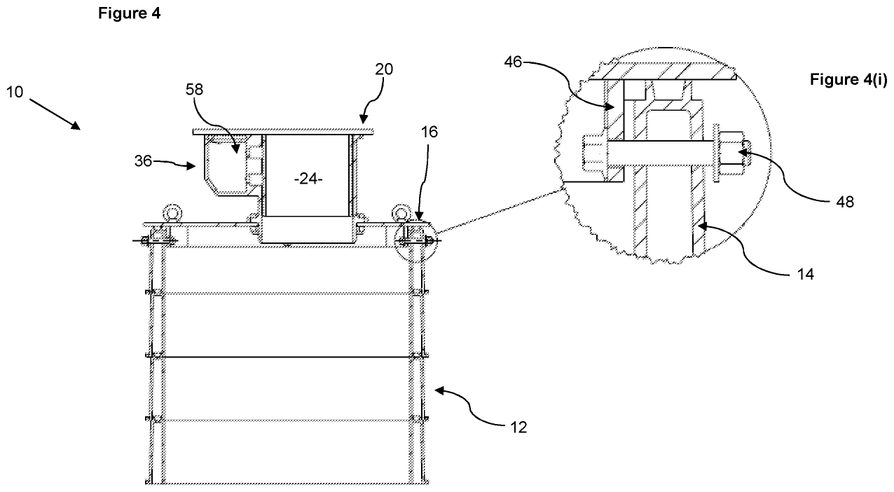

FIG. 4 shows the connection region 38 of the adapter coupling 20 in detail. This is formed as a side port 58 on the side of the neck portion 22, thereby allowing a fastener to be accessed from both inside the collar 28 of the electric-vehicle-charger adapter plate 26 and from inside the side port 58. Releasable engagement of the electric-vehicle-charger adapter plate 26 and raising frame element 16 is therefore possible even once the base structure 12 is installed to block access to the cabling void. Inset FIG. 4(i) shows a corresponding fastening between the base structure 12 and a base coupling 46 of the raising frame element 16, illustrated as a skirt depending from the adapter coupling and/or perimetric flange 18, which is connected via a screw-threaded fastener 48 such as a nut and bolt.

It will be appreciated that whilst the raising frame element 16 shown is receivable into the base structure 12, it could easily cap the base structure 12 instead, and therefore the base coupling 46 shown is merely illustrative. Similarly, the adapter coupling 20 is shown as projecting above the level of the perimetric flange 18, but in such a scenario, no flange would be necessary. The adapter coupling 20 could also be flush or level with the base coupling 46. Additionally, it may be possible to integrally form the raising frame element 16 with the base structure 12, so that they are permanently connected to one another. A formal base coupling would be unnecessary in such a scenario.

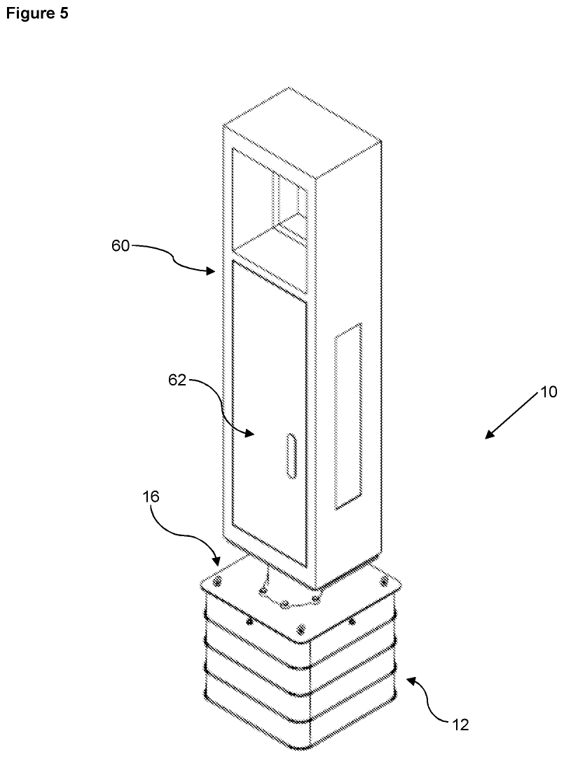

An indicative connection between an electric vehicle charger 60 and the electric-vehicle-charger adapter plate 26 is shown in FIG. 5. The base of the electric vehicle charger 60 may be mounted to the mounting points 34 of the electric-vehicle-charger adapter plate 26, for instance, by access through the cabinet door 62 of the electric vehicle charger 60.

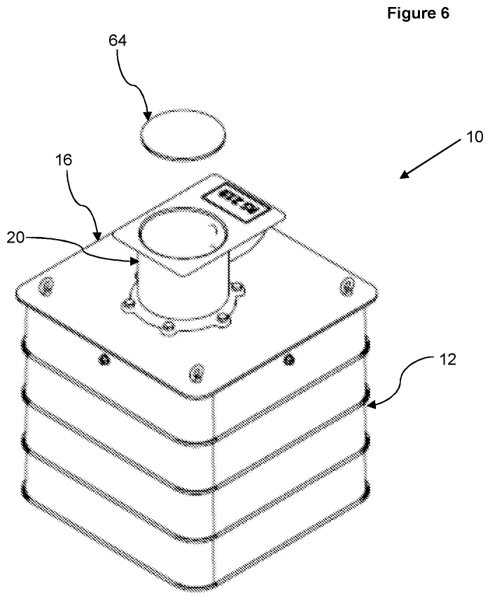

By utilising a modular electric vehicle charging foundation system 10, a single electric vehicle charger 60 can be installed at a site. However, the strength of the modular electric vehicle charging foundation system 10 is that the modular engagement between the raising frame element 16 and the electric-vehicle-charger adapter plate 26 allows for the electric-vehicle-charger adapter plate 26 to be demounted and replaced with either a blanking cover 64, such as the circular cap or similar manhole cover which is illustrated in FIG. 6, should the removal of the electric vehicle charger 60 be desirable, or with a different electric-vehicle-charger adapter plate suitable for use with a different electric vehicle charger. This advantageously allows for the replacement of different types of electric vehicle charger without needing to perform groundwork. All actions can be undertaken above ground.

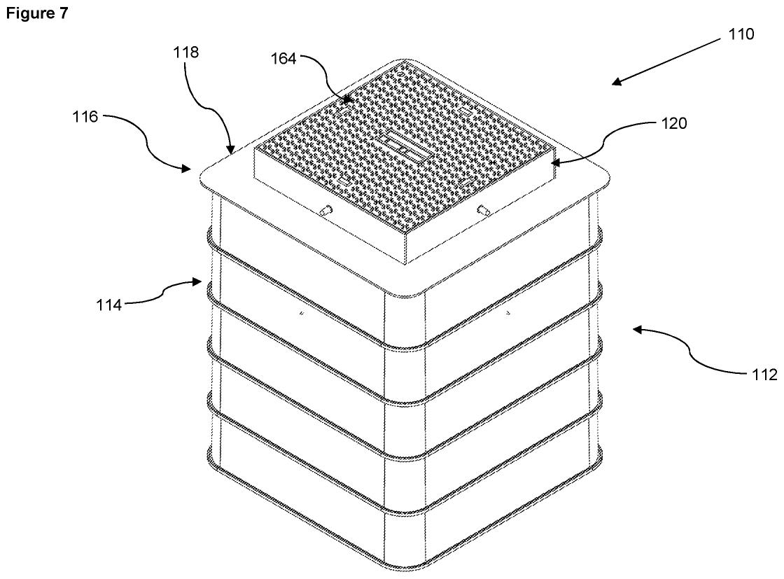

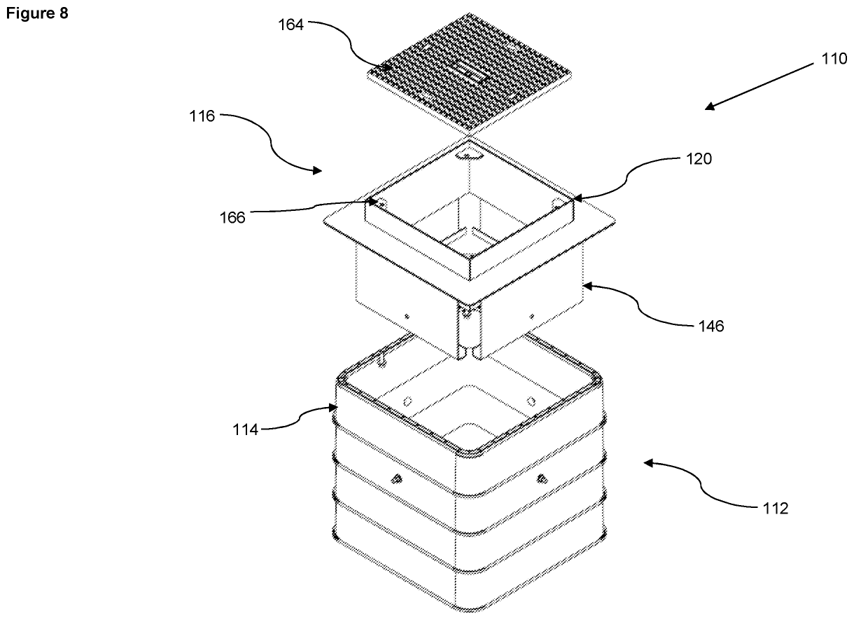

FIGS. 7 and 8 show a second embodiment of a modular electric vehicle charging foundation system, referenced globally at 110. Identical or similar features of the embodiment to those disclosed in connection with the first embodiment will be referenced using identical or similar reference numerals, and further detailed description will be omitted for brevity.

The base structure 112 is substantially identical to that shown in the first embodiment; however, the raising frame element 116 now has a rectilinear adapter coupling 120, as opposed to the tubular arrangement of the first embodiment. The skirt 146 has a greater length extending into the cabling void, so as to engage with the second base portion 114. The perimetric flange 118 still seats onto the top of the base structure 112.

The modular electric vehicle charging foundation system 110 includes a blanking cover 164, such as a standard manhole cover, which is seatable onto the raising frame element 116, and which can be fastened in place via fastening elements engagable through the corresponding receivers 166 of the raising frame element 116.

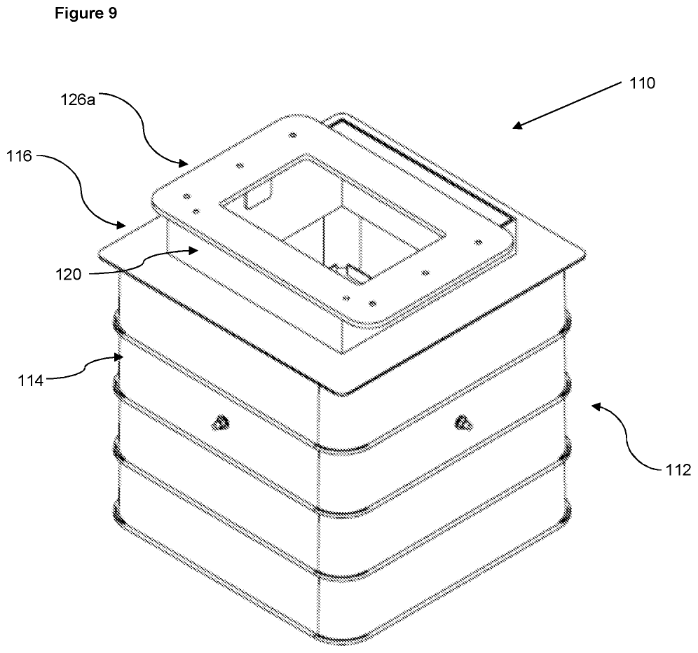

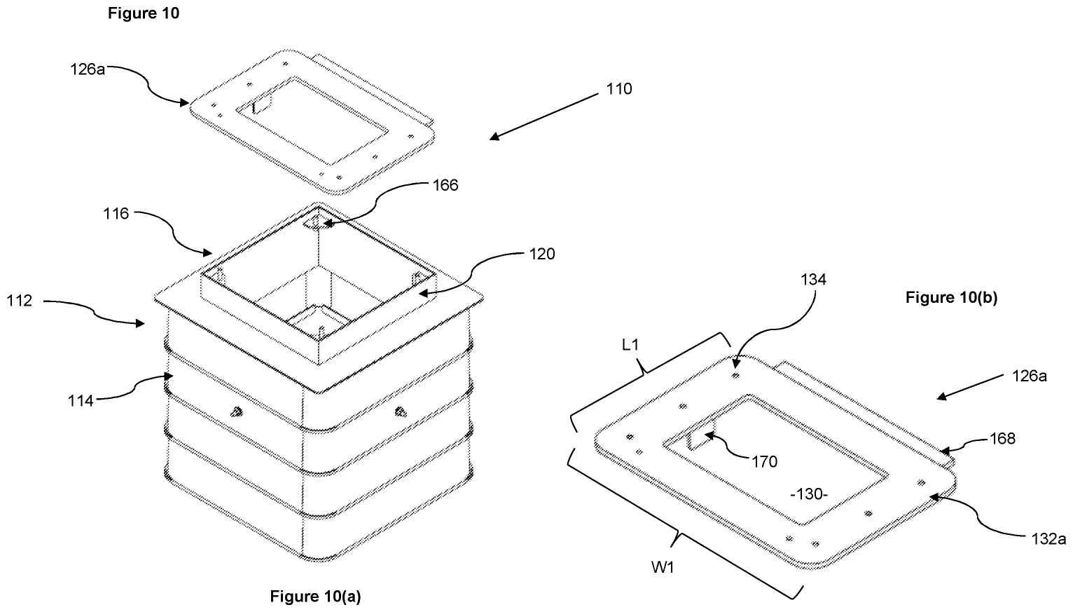

FIGS. 9 and 10 show the modular electric vehicle charging foundation system 110 with an alternative electric-vehicle-charger adapter plate 126a. The plate body 132a of this electric-vehicle-charger adapter plate 126a has a width W1 which is greater than its length L1, best illustrated in FIG. 10(b), with the width W1 being greater than a first dimension of the adapter coupling 120. This allows the mounting points 134 to overhang the adapter coupling 120, as seen in FIG. 9.

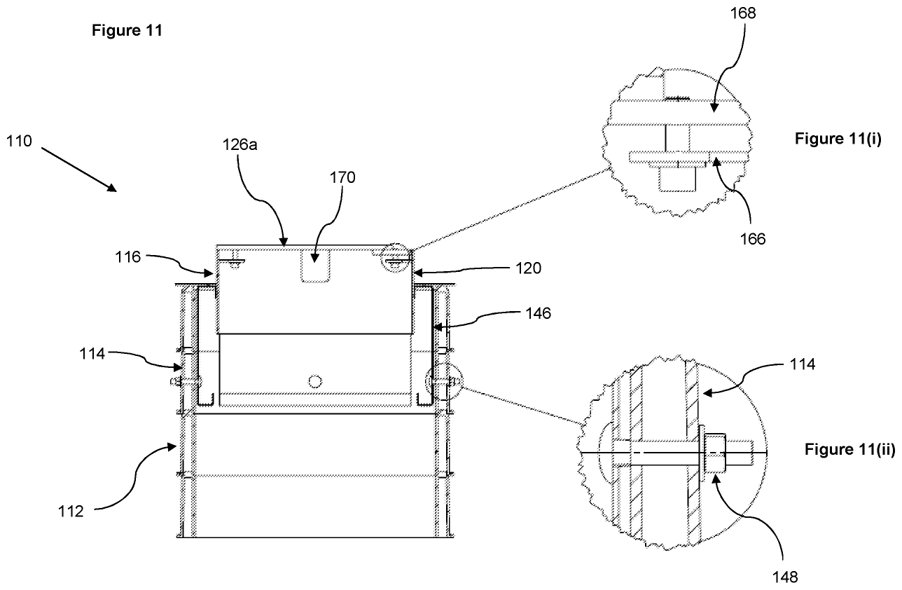

Since the length L1 of the plate body 132a of the electric-vehicle-charger adapter plate 126a is less than that of a second dimension of the adapter coupling 120, and as such, an insertion plate 168 is provided to bridge any void space which would otherwise allow for ingress of water into the base structure 112 from above. This engagement is visible in FIG. 11.

The electric-vehicle-charger adapter plate 126a includes first and second dependent locators 170 which have much the same purpose as the skirt of the raising frame element 116, that is, to correctly orient and align the electric-vehicle-charger adapter plate 126a in the adapter coupling 120. The locators 170 abuttably engage with the walls of the adapter coupling 120, keeping the electric-vehicle-charger adapter plate 126a aligned. The fasteners 148 which hold the electric-vehicle-charger adapter plate 126a in position on the raising frame element 116 are illustrated in inset FIG. 10(i), and these may be provided as screw-threaded fasteners or alternative fastening members, such as worm screws.

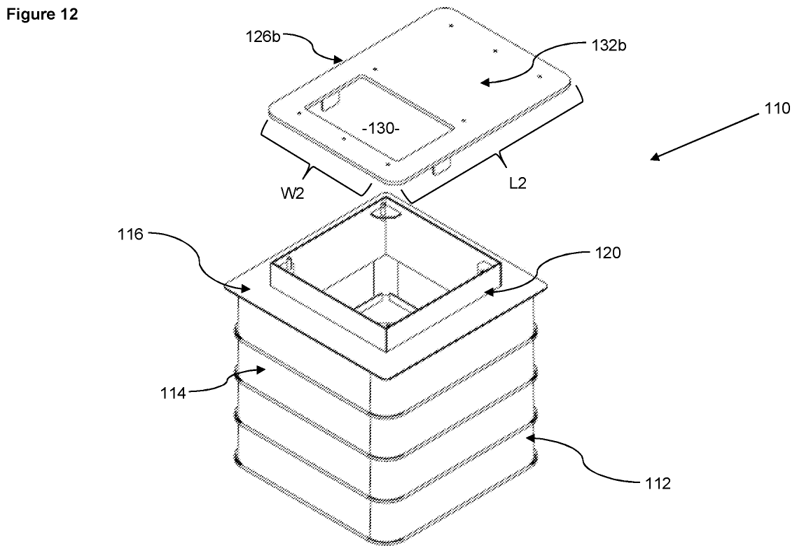

FIG. 12 shows the modular electric vehicle charging foundation system 110 with a further alternative electric-vehicle-charger adapter plate 126b. This electric-vehicle-charger adapter plate 126b has a plate body 132b which has a length L2 which is greater than its width W2, with the length L2 being greater than a second dimension of the adapter coupling 120. This provides a much larger base for a bigger electric vehicle charger than that of the previous electric-vehicle-charger adapter plate 126a, and also eliminates the need for an insertion plate.

In this embodiment, some of the mounting points 134 are positioned on laterally overhanging parts of the plate body 132b, whilst some lie within the area of the aperture 130 of the raising frame element 116.

It is preferred, however, that the cabling aperture 130 has the same dimensions across a set of a plurality of electric-vehicle-charger adapter plates 126a, 126b, so that no additional manipulation of the subsurface cables is required when switching between different electric vehicle chargers.

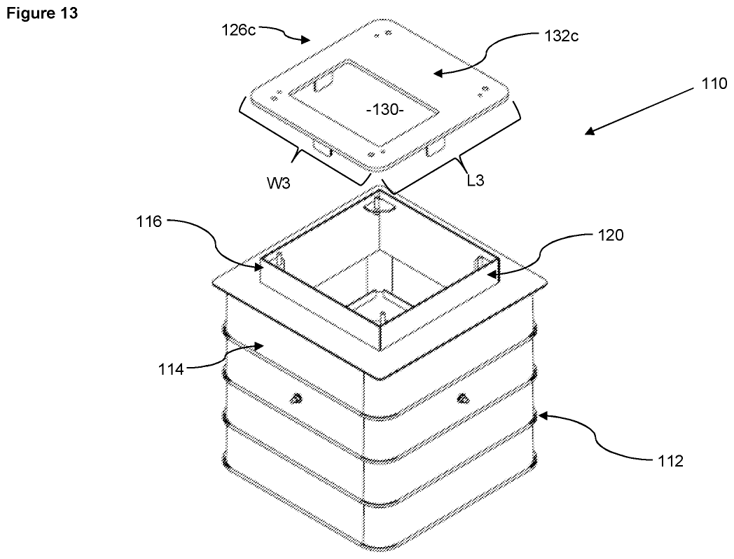

FIG. 13 shows the modular electric vehicle charging foundation system 110 with a further alternative electric-vehicle-charger adapter plate 126c. This electric-vehicle-charger adapter plate 126c has a plate body 132c which an equal width W3 and length L3. This provides a square base for an electric vehicle charger.

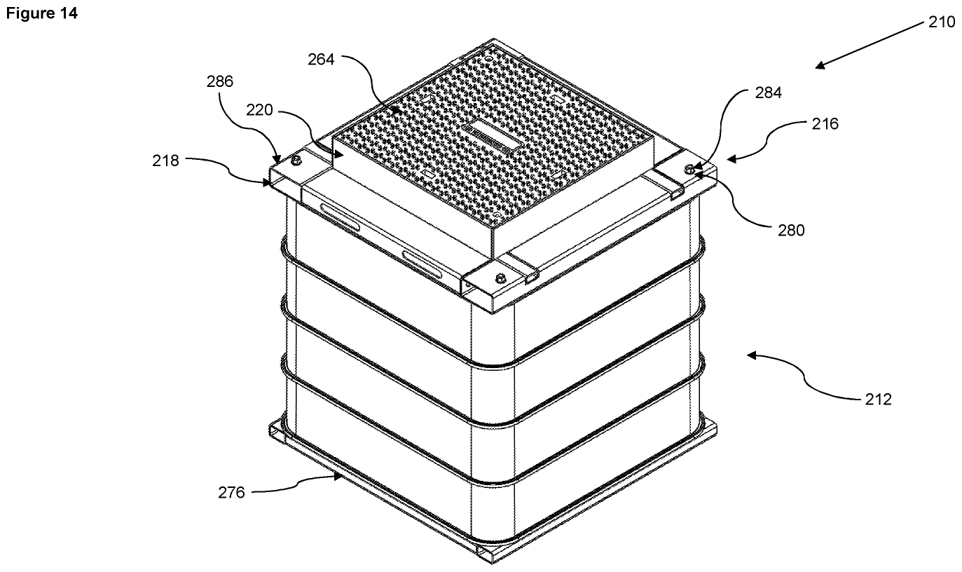

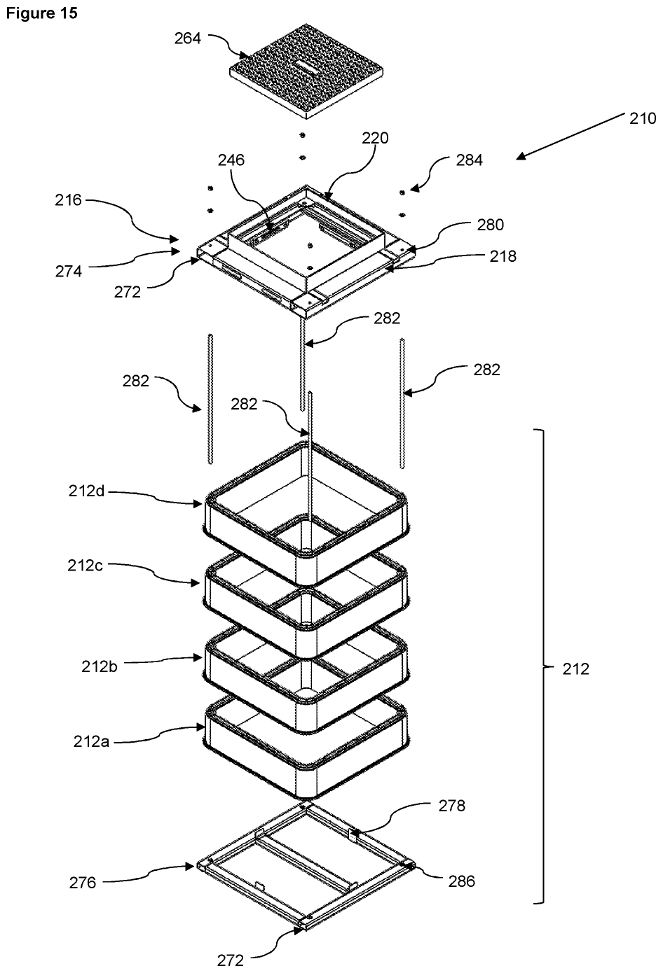

An alternative construction of modular electric vehicle charging foundation system is illustrated in FIGS. 14 and 15, referenced globally at 210, and which has a stronger and more easily installable base structure 212. Identical or similar features to those described in respect of the preceding embodiments will be referenced using identical or similar reference numerals, and further detailed description is omitted for brevity.

The raising frame element 216 is broadly the same as that of the second embodiment, having a rectilinear adapter coupling 220, here shown with a blanking cover 264, and a skirt 246, though the skirt 246 has a significantly reduced depth penetrating into the base structure for the reasons outlined below.

The perimetric flange 218 seats onto the top of the base structure 212, though here is not formed as a plate-like member, but is instead formed from structural members 272 which have a greater height in an installed condition. The perimetric flange 218 thereby in essence forms a top member 274 of the base structure 212.

The base structure 212 comprises a plurality of chamber body portions 212a, 212b, 212c, 212d which are stackably engaged on top of one another once assembled. Whilst four chamber body portions are shown, it will be apparent that any number of chamber body portions could be provided. Indeed, it is entirely feasible that a single, non-portioned base structure 212 could be provided.

The base structure 212 further comprises a base member 276, preferably formed as a frame having four structural members 272 arranged in the shape of a rectangle, surrounding a central aperture. The structural members 272 may be hollow to reduce the weight of the base member 276; this applies equally to the structural members 272 of the raising frame element 214.

The base member 276 is shown to have at least one locator 278. The locators 278 are integrally formed with an inner surface of the frame, and are effectively the counterpart of the skirt 246 of the raising frame element 216. The locators 278 each have an in-use upwardly projecting tan which receivably engages with a side wall of a first chamber body portion 212a.

The first chamber body portion 212a is attached to the base member 276, which would be received on the base of any trench in which the modular electric vehicle charging foundation system 210 is to be installed. The remaining chamber body portions 212b, 212c, 212d are then stacked on top of the first chamber body portion 212a. The raising frame element 216 can then be positioned on top of the fourth chamber body portion 212d in the stack, and thus the raising frame element 216 is parallel to the base member 276 once installed.

The raising frame member 216 includes a plurality of apertures 280 which are dimensioned to receive a securing element 282 therethrough. A connector 284, such as a nut and washer, is also provided for fixing the securing element 282 to the raising frame element 216. This connector 284 could be recessed inside the height of the structural member 272, if desired, though the connector 284 is shown engaging with a top surface 286 of the raising frame member 216 to provide an anchoring point.

Each securing element 282 is an elongate member which is received by a securing element channel running through the base structure 212. The securing element 282 is made of a rigid material such as plastic, fibreglass, or metal. A top portion of the securing element 282 is engaged with the raising frame element 216 using the connector 284, the top portion here having an external screw thread. The securing element 282 is dimensioned to a correct height of the base structure 212 in order to interconnect the raising frame element 216 with the base member 276, though it will be apparent that a modularly extendible securing element could be provided, which increases in length according to the height of the base structure 212.

The base member 276 has a corresponding anchoring connector 286 associated therewith, which is illustrated in FIG. 15 as an aperture into the structural member 272 thereof through which a bottom portion of the securing element 282 can enter.

In the embodiment illustrated, the anchoring connector 286 extends up into the structural member 272, in the form of a coach bolt coupled to a stud connector, which screw-threadingly engages with the securing element 282 when inserted through the aperture.

When assembled, as is shown in FIG. 14, the securing element 282 is housed within a securing element channel between inner and outer walls of the base structure 212. The anchoring connector 286 and a bottom portion of the securing element 282 screw-threadingly interengage with one another, and the raising frame element 216 is coupled to the top portion of the securing element 282 by the connector 284. The raising frame element 216 and base member 276 are thus interconnected by the securing elements 282, clamping the chamber body portions 212a, 212b, 212c, 212d of the base structure 212 together. The coupling between the anchoring connector 286 and the securing element 282 can thus be tightened entirely from above, by cranking of the connector 284 to provide a clamping force to hold the position of the base structure 212. A strong modular base is thus formed for the modular electric vehicle charging foundation system 210.

It will be apparent that whilst the raising frame elements has been defined as sitting and spanning a single base structure at once, larger base structures are known. It will thus be appreciated that a plurality of different raising frame elements could be attached to a single base structure, to provide a plurality of chargers at a single site. This is intended to fall within the scope of the present invention.

Due to the more difficult cabling requirements associated with electric vehicle chargers, which have thick and unwieldy subsurface cabling, the present invention is very suited towards the installation of such systems. However, it will be appreciated that the present invention could be applied to any appropriate road furniture, such as electrical control cabinets, in which case adapter plates which are not directed to electric vehicle chargers could be utilised, either separately, or as modular replacements for the electric-vehicle-charger adapter plates addressed above.

The provision of a modular electric vehicle charging foundation system comprising a base structure, a raising frame, and a plurality of different adapter plates enables the selective alteration of an installation site to suit a new electric vehicle charger to be installed, thus creating a true modular electric vehicle charging system. In a preferred embodiment, there is provided a single blanking cover, which allows the system to be capped off once groundworks is complete to permit safe crossing over the site by pedestrians or vehicles, and then an adapter plate which is installed at a later date which is bespoke to the electric vehicle charger to be installed. Indeed, this system is readily adaptable to other types of road furniture, including but not limited to traffic light signal boxes, electrical cabinets, and other junction box architecture.

It is thus possible to provide a method of reducing groundwork requirements for an electric vehicle charger installation site, by installing a base structure in a trench at a desired site for the electric vehicle charger; engaging a raising frame element with an upper portion of the base structure, the raising frame comprising a perimetric flange, a skirt receivable into the cabling void of the base structure and having at least one fastening means for fastening the skirt to the base structure, and an adapter coupling; and then selecting a suitable electric-vehicle-charger adapter plate from a plurality of different electric-vehicle-charger adapter plates each having a cabling aperture therethrough, wherein the selected electric-vehicle-charger adapter plate is releasably engagable with the adapter coupling to provide a foundation for a selected electric vehicle charger.

The words ‘comprises/comprising’ and the words ‘having/including’ when used herein with reference to the present invention are used to specify the presence of stated features, integers, steps, or components, but do not preclude the presence or addition of one or more other features, integers, steps, components or groups thereof.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

The embodiments described above are provided by way of examples only, and various other modifications will be apparent to persons skilled in the field without departing from the scope of the invention as defined herein.

1. A modular electric vehicle charging foundation system (10; 110; 210) comprising:
a base structure (12; 112; 212) defining a cabling void;
a raising frame element (16; 116; 216) connected or connectable to an upper portion of the base structure (12; 112; 212) and having an adapter coupling (20; 120; 220);
an electric-vehicle-charger adapter plate (26; 126) having a cabling aperture (30; 130) therethrough, the electric-vehicle-charger adapter plate (26; 126a, 126b, 126c) being releasably engagable with the adapter coupling (20; 120; 220) to provide a foundation for an electric vehicle charger once installed; and
a blanking cover (64; 164; 264) releasably engagable with the adapter coupling (20; 120; 220), the electric-vehicle-charger adapter plate (26; 126a, 126b, 126c) and blanking cover being selectably interchangeable.

2. A modular electric vehicle charging foundation system (10; 110; 210) as claimed in claim 1, wherein the base structure (12; 112; 212) is formed from a plurality of interengagable base portions.

3. A modular electric vehicle charging foundation system (10; 110; 210) as claimed in claim 2, wherein the base portions are stackable on top of one another.

4. A modular electric vehicle charging foundation system (210) as claimed in claim 2 or claim 3, wherein the base structure (212) further comprises a base member (276) having an anchoring connector (286) thereon; and a securing element (282) connectable with the anchoring connector (286) and connectable to the raising frame element (216) to clampingly secure the base portions between the base member (276) and the raising frame element (216).

5. A modular electric vehicle charging foundation system (210) as claimed in claim 4, the base structure (212) comprising an inner wall and an outer wall, wherein the inner and outer walls define a securing element channel for receiving the securing element (282).

6. A modular electric vehicle charging foundation system (210) as claimed in claim 4 or claim 5, wherein the securing element (282) and the anchoring connector (286) screw-threadingly interengage with one another.

7. A modular electric vehicle charging foundation system (210) as claimed in any one of claims 4 to 6, wherein the base member (276) comprises at least one locator (278) for locating at least one base portion thereon.

8. A modular electric vehicle charging foundation system (110; 210) as claimed in any one of the preceding claims, wherein the adapter coupling (120; 220) is formed having a rectilinear profile.

9. A modular electric vehicle charging foundation system (10) as claimed in any one of claims 1 to 7, wherein the adapter coupling (20) is formed having a tubular profile.

10. A modular electric vehicle charging foundation system (10; 110; 210) as claimed in any one of the preceding claims, wherein the electric-vehicle-charger adapter plate (26; 126a, 126b, 126c) comprises at least one locator which depends from a plate body (32; 132a, 132b, 132c) thereof.

11. A modular electric vehicle charging foundation system (10; 110; 210) as claimed in any one of the preceding claims, wherein at least part of the electric-vehicle-adapter plate (26; 126a, 126b, 126c) extends laterally outwardly from the adapter coupling (20; 120; 220).

12. A modular electric vehicle charging foundation system (10; 110; 210) as claimed in claim 11, wherein at least part of the electric-vehicle-adapter plate (26; 126a, 126b, 126c) extends laterally outwardly from a perimetric flange (18; 118; 218) thereof.

13. A modular electric vehicle charging foundation system (10; 110; 210) as claimed in any one of the preceding claims, wherein a plurality of different electric-vehicle-charger adapter plates (26; 126a, 126b, 126c) is provided, each different electric-vehicle-charger adapter plate (26; 126a, 126b, 126c) being releasably engagable with the upper frame section to provide a foundation for a different electric vehicle charger (60) once installed.

14. A modular electric vehicle charging foundation system (10; 110; 210) as claimed in claim 13, wherein a dimension of the cabling aperture for each of the plurality of different electric-vehicle-adapter plates (26; 126a, 126b, 126c) is identical for each of the plurality of different electric-vehicle-adapter plates (26; 126a, 126b, 126c).

15. A modular electric vehicle charging foundation system (10; 110; 210) as claimed in claim 13 or claim 14, wherein each of the plurality of different electric-vehicle-adapter plates (26; 126a, 126b, 126c) comprises electric-vehicle-charger-specific mounting points thereon.

16. A modular electric vehicle charging foundation system (10; 110; 210) as claimed in any one of the preceding claims, wherein the raising frame element (16; 116; 216) includes a connection region at the adapter coupling (20; 120; 220) allows access to a fastening means to the electric-vehicle-charger adapter plate (26; 126a, 126b, 126c).

17. A modular electric vehicle charging foundation system (10; 110; 210) as claimed in claim 16, wherein the electric-vehicle-charger adapter plate (26; 126a, 126b, 126c) includes an access aperture (36) to permit access therethrough to the connection region.

18. A modular electric vehicle charging system comprising a modular electric vehicle charging foundation system (10; 110; 210) as claimed in any one of the preceding claims, and an electric vehicle charger (60) engagable with the electric vehicle charger adapter plate (26; 126a, 126b, 126c).

19. A modular electric vehicle charging foundation system (10; 110; 210) comprising:
a base structure (12; 112; 212) defining a cabling void;
a raising frame element (16; 116; 216) engagable connected or connectable to an upper portion of the base structure (12; 112; 212) and having an adapter coupling (20; 120; 220); and
a plurality of different electric-vehicle-charger adapter plates (26; 126a, 126b, 126c), each different electric-vehicle-charger adapter plate (26; 126a, 126b, 126c) having a cabling aperture (30; 130) therethrough, each different electric-vehicle-charger adapter plate (26; 126a, 126b, 126c) being releasably engagable with the adapter coupling (20; 120; 220) to provide a foundation for a different electric vehicle charger (60) once installed.

20. A method of reducing groundwork requirements for an electric vehicle charger installation site, the method comprising the steps of:
a] installing a base structure (12; 112; 212) in a trench at a desired site for the electric vehicle charger (60);
b] engaging a raising frame element (16; 116; 216) with an upper portion of the base structure (20; 120; 220), the raising frame element (16; 116; 216) being connected or connectable to the upper portion of the base structure (12; 112; 212) and having an adapter coupling (20; 120; 220); and
c] selecting a suitable electric-vehicle-charger adapter plate (26; 126a, 126b, 126c) from a plurality of different electric-vehicle-charger adapter plates (26; 126a, 126b, 126c) each having a cabling aperture (30; 130) therethrough, wherein the selected electric-vehicle-charger adapter plate (26; 126a, 126b, 126c) is releasably engagable with the adapter coupling (20; 120; 220) to provide a foundation for a selected electric vehicle charger (60).

21. A modular foundation system (10; 110; 210) for road furniture, the system comprising:
a base structure (12; 112; 212) defining a cabling void;
a raising frame element (16; 116; 216) connected or connectable to an upper portion of the base structure (12; 112; 212) and having an adapter coupling (20; 120; 220);
an adapter plate (26; 126) having a cabling aperture (30; 130) therethrough, the adapter plate (26; 126a, 126b, 126c) being releasably engagable with the adapter coupling (20; 120; 220) to provide a foundation for an item of road furniture once installed; and
a blanking cover (64; 164; 264) releasably engagable with the adapter coupling (20; 120; 220), the adapter plate (26; 126a, 126b, 126c) and blanking cover being selectably interchangeable.
